(19) United States
(12) Patent Application Publication
(10) Pub. No.: US 2017/0318534 A1
(43) Pub. Date: Nov. 2, 2017

(54) PORTABLE TERMINAL, PORTABLE TERMINAL OPERATION SYSTEM, AND COMMUNICATION CONTROL METHOD

(71) Applicant: DENSO CORPORATION, Kariya-city, Aichi-pref. (JP)

(72) Inventors: Masaya TAKATSUJI, Kariya-city (JP); Yoshitaka OZAKI, Kariya-city (JP); Hiroki UKAI, Kariya-city (JP); Masaya ITO, Kariya-city (JP); Takashi ICHIDA, Kariya-city (JP)

(21) Appl. No.: 15/523,305

(22) PCT Filed: Nov. 27, 2015
(86) PCT No.: PCT/JP2015/005920

§ 371 Date: Apr. 28, 2017

(30) Foreign Application Priority Data
Dec. 8, 2014 (JP) 2014-247937

(51) Int. Cl. H04W 52/02; H04W 4/00; H04W 76/04; H04W 88/02

(52) U.S. Cl. CPC H04W 52/0225; H04W 76/048; H04W 4/008; H04W 88/02

(57) ABSTRACT

A portable terminal, providing a portable terminal operation system together with a controller that starts transmission of a connection standby packet when receiving a disconnection request and ends the transmission of the connection standby packet when receiving a connection request, includes: a disconnection request transmission device that transmits the disconnection request to the controller when notified that an application body of a first cooperative application shifts to a background in a case where a start request for a second cooperative application is generated while the first cooperative application is running; and a connection request transmission device that starts monitoring reception of the connection standby packet when notified that the second cooperative application has been started in a case where the start request is notified from the first cooperative application to the second cooperative application, and transmits the connection request to the controller when receiving the connection standby packet.

### CROSS REFERENCE TO RELATED APPLICATION

This application is based on Japanese Patent Application No. 2014-247937 filed on Dec. 8, 2014, the disclosure of which is incorporated herein by reference.

### TECHNICAL FIELD

The present disclosure relates to a portable terminal, a portable terminal operation system, a communication control program, and a communication control method.

### BACKGROUND ART

In recent years, portable terminals such as smartphones have become widespread. This kind of portable terminal is capable of executing a cooperative application (i.e., a cooperative application) such as destination retrieval or route guide in cooperation with a vehicle device such as a navigation device. Further, this kind of portable terminal is based on the premise that a user holds the portable terminal in his/her hand to use, and it is necessary to fix the eyes on a screen of the portable terminal to some extent to operate the portable terminal. Thus, when a user operates the portable terminal during driving, the driving may be interfered. Thus, it is not preferred to operate the portable terminal during driving. In view of this point, for example, Patent Literature 1 discloses a configuration that is provided with an on-vehicle device which captures an image of a screen of a portable terminal, displays the screen of the portable terminal on the on-vehicle device, and feedbacks an operation to the on-vehicle device performed by a user to the portable terminal.

However, in the configuration disclosed in Patent Literature 1, it is necessary for the on-vehicle device to include an imaging device for capturing an image of the screen of the portable terminal. Further, a user operates a touch panel of the screen displayed on the on-vehicle device, which is not preferred in view of safety. In view of such circumstances, the applicant of the present disclosure filed Japanese Patent Application No. 2014-195115. In Japanese Patent Application No. 2014-195115, a screen of a portable terminal is displayed on an on-vehicle device, and a controller which receives an operation to the portable terminal is provided. When a user operates the controller, information of the operation is transmitted from the controller to the portable terminal to control the execution of a cooperative application in the portable terminal.

In the configuration provided with a controller in such a manner, Bluetooth (registered trademark) low energy (LE) (hereinbelow, referred to as BLE) communication is often used as a communication system between the portable terminal and the controller to reduce power consumption in the controller. In this case, the portable terminal serves as a master device, and the controller serves as a slave device, so that the controller transmits an advertising packet. However, when a time during which the portable terminal is not connected to the controller becomes longer, a time of continuously transmitting the advertising packet by the controller becomes longer. Accordingly, power consumption in the controller disadvantageously increases. In particular, when the controller is battery-driven (i.e., battery-driven), reducing power consumption is highly required.

### PRIOR ART LITERATURES

### Patent Literature

Patent Literature 1: JP-2012-3374-A

### SUMMARY OF INVENTION

It is an object of the present disclosure to provide a portable terminal, a portable terminal operation system, a communication control program, and a communication control method capable of appropriately reducing power consumption in a controller in a configuration in which the controller transmits a connection standby packet to a portable terminal.

According to a first aspect of the present disclosure, a portable terminal for providing a portable terminal operation system together with a controller that starts transmission of a connection standby packet when receiving a disconnection request from an external device and ends the transmission of the connection standby packet when receiving a connection request from the external device, the portable terminal includes: a disconnection request transmission device that transmits the disconnection request to the controller when notified that an application body of a first cooperative application shifts to a background in a case where a start request for a second cooperative application is generated while the first cooperative application is running; and a connection request transmission device that starts monitoring reception of the connection standby packet from the controller when notified that the second cooperative application has been started in a case where the start request is notified from the application body of the first cooperative application to an application body of the second cooperative application, and transmits the connection request to the controller when receiving the connection standby packet from the controller.

In the above case, the controller starts the transmission of the connection standby packet when receiving the disconnection request from the disconnection request transmission device of the portable terminal and then ends the transmission of the connection standby packet when receiving the connection request from the connection request transmission device of the portable terminal. In this manner, when the start request for the second cooperative application is generated while the first cooperative application is running in the portable terminal, it is possible to control the start and end of the transmission of the connection standby packet from the controller by, for example, transmitting the disconnection request to the controller by the disconnection request transmission device in response to the request from the application body of the first cooperative application or the body of the portable terminal and transmitting the connection request to the controller by the connection request transmission device in response to the request from the application body of the second cooperative application or the body of the portable terminal. As a result, it is possible to prevent the controller from continuously transmitting the connection standby packet to thereby appropriately reduce the power consumption in the controller. In particular, when the controller is battery-driven, a long life of the battery can be achieved by reduction of the power consumption.

According to a second aspect of the present disclosure, a portable terminal for providing a portable terminal operation system together with a controller that starts transmission of a connection standby packet when receiving a disconnection request from an external device and ends the transmission of the connection standby packet when receiving a connection request from the external device, the portable terminal includes: a disconnection request transmission device that transmits the disconnection request to the controller when notified that an application body of a cooperative application shifts to a background in a case where an interrupt request from a different application or a body of the portable terminal generated while the cooperative application is running; and a connection request transmission device that starts monitoring of reception of the connection standby packet from the controller when notified that the application body of the cooperative application shifts to a foreground, and transmits the connection request to the controller when receiving the connection standby packet from the controller.

In the above portable terminal, even when the interrupt request from the different application or the body of the portable terminal is generated while the cooperative application is running, it is possible to control the start and end of the transmission of the connection standby packet from the controller by, for example, transmitting the disconnection request to the controller by the disconnection request transmission device in response to the request from the application body of the cooperative application or the body of the portable terminal and transmitting the connection request to the controller by the connection request transmission device in response to the request from the application body of the cooperative application or the body of the portable terminal. As a result, it is possible to prevent the controller from continuously transmitting the connection standby packet to thereby appropriately reduce the power consumption in the controller.

According to a third aspect of the present disclosure, a communication control program that controls a control device of a portable terminal, for providing a portable terminal operation system together with a controller that starts transmission of a connection standby packet when receiving a disconnection request from an external device and ends the transmission of the connection standby packet when receiving a connection request from the external device, to execute: a disconnection request transmission process of transmitting the disconnection request to the controller when notified that an application body of a first cooperative application shifts to a background in a case where a start request for a second cooperative application is generated while the first cooperative application is running; and a connection request transmission process of starting monitoring of reception of the connection standby packet from the controller when notified that the second cooperative application has been started in a case where the start request is notified from the application body of the first cooperative application to an application body of the second cooperative application, and transmitting the connection request to the controller when receiving the connection standby packet from the controller.

In the above case, the controller starts the transmission of the connection standby packet when receiving the disconnection request from the portable terminal and then ends the transmission of the connection standby packet when receiving the connection request from the portable terminal. In this manner, when the start request for the second cooperative application is generated while the first cooperative application is running in the portable terminal, it is possible to control the start and end of the transmission of the connection standby packet from the controller by, for example, transmitting the disconnection request to the controller by the disconnection request transmission device in response to the request from the application body of the first cooperative application or the body of the portable terminal and transmitting the connection request to the controller by the connection request transmission device in response to the request from the application body of the second cooperative application or the body of the portable terminal. As a result, it is possible to prevent the controller from continuously transmitting the connection standby packet to thereby appropriately reduce the power consumption in the controller. In particular, when the controller is battery-driven, a long life of the battery can be achieved by reduction of the power consumption.

According to a fourth aspect of the present disclosure, a communication control program that controls a portable terminal, for providing a portable terminal operation system together with a controller that starts transmission of a connection standby packet when receiving a disconnection request from an external device and ends the transmission of the connection standby packet when receiving a connection request from the external device, to execute: a disconnection request transmission process of transmitting the disconnection request to the controller when notified that an application body of a cooperative application shifts to a background in a case where an interrupt request from a different application or a body of the portable terminal is generated while the cooperative application is running; and a connection request transmission process of starting monitoring of reception of the connection standby packet from the controller when notified that the application body of the cooperative application shifts to a foreground, and transmitting the connection request to the controller when receiving the connection standby packet from the controller.

In the above, even when the interrupt request from the different application or the body of the portable terminal is generated while the cooperative application is running, it is possible to control the start and end of the transmission of the connection standby packet from the controller by, for example, transmitting the disconnection request to the controller in response to the request from the application body of the cooperative application or the body of the portable terminal and transmitting the connection request to the controller in response to the request from the application body of the cooperative application or the body of the portable terminal. As a result, it is possible to prevent the controller from continuously transmitting the connection standby packet to thereby appropriately reduce the power consumption in the controller.

According to a fifth aspect of the present disclosure, a communication control method for a portable terminal providing a portable terminal operation system together with a controller that starts transmission of a connection standby packet when receiving a disconnection request from an external device and ends the transmission of the connection standby packet when receiving a connection request from the external device, the communication control method includes: transmitting the disconnection request to the controller when notified that an application body of a first cooperative application shifts to a background in a case where a start request for a second cooperative application is generated while the first cooperative application is running; and starting monitoring of reception of the connection standby packet from the controller when notified that the second cooperative application has been started in a case where the start request is notified from the application body of the first cooperative application to an application body of the second cooperative application, and transmitting the connection request to the controller when receiving the connection standby packet from the controller.

In the above case, the controller starts the transmission of the connection standby packet when receiving the disconnection request from the portable terminal and then ends the transmission of the connection standby packet when receiving the connection request from the portable terminal. In this manner, when the start request for the second cooperative application is generated while the first cooperative application is running in the portable terminal, it is possible to control the start and end of the transmission of the connection standby packet from the controller by, for example, transmitting the disconnection request to the controller by the disconnection request transmission device in response to the request from the application body of the first cooperative application or the body of the portable terminal and transmitting the connection request to the controller by the connection request transmission device in response to the request from the application body of the second cooperative application or the body of the portable terminal. As a result, it is possible to prevent the controller from continuously transmitting the connection standby packet to thereby appropriately reduce the power consumption in the controller. In particular, when the controller is battery-driven, a long life of the battery can be achieved by the reduction of the power consumption.

According to a sixth aspect of the present disclosure, a communication control method for a portable terminal providing a portable terminal operation system together with a controller that starts transmission of a connection standby packet when receiving a disconnection request from an external device and ends the transmission of the connection standby packet when receiving a connection request from the external device, the communication control method includes: transmitting the disconnection request to the controller when notified that an application body of a cooperative application shifts to a background in a case where an interrupt request from a different application or a body of the portable terminal is generated when the cooperative application is running; and starting monitoring of reception of the connection standby packet from the controller when notified that the application body of the cooperative application shifts to a foreground, and transmitting the connection request to the controller when receiving the connection standby packet from the controller.

In the above, even when the interrupt request from the different application or the body of the portable terminal is generated while the cooperative application is running, it is possible to control the start and end of the transmission of the connection standby packet from the controller by, for example, transmitting the disconnection request to the controller in response to the request from the application body of the cooperative application or the body of the portable terminal and transmitting the connection request to the controller in response to the request from the application body of the cooperative application or the body of the portable terminal. As a result, it is possible to prevent the controller from continuously transmitting the connection standby packet to thereby appropriately reduce the power consumption in the controller.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram illustrating an embodiment of the present disclosure;

FIG. 2 is a diagram illustrating the entire configuration;

FIG. 3 is a diagram schematically illustrating a use form;

FIG. 4 is a diagram (No. 1) illustrating a sequence;

FIG. 5 is a flow chart illustrating a process performed by a BLE communication unit of a controller;

FIG. 6 is a flow chart illustrating a process performed by a library of a cooperative application B;

FIG. 7 is a diagram (No. 2) illustrating a sequence;

FIG. 8 is a diagram (No. 3) illustrating a sequence; and

FIG. 9 is a diagram (No. 4) illustrating a sequence.

### EMBODIMENTS FOR CARRYING OUT INVENTION

Hereinbelow, an embodiment of the present disclosure will be described with reference to the drawings.

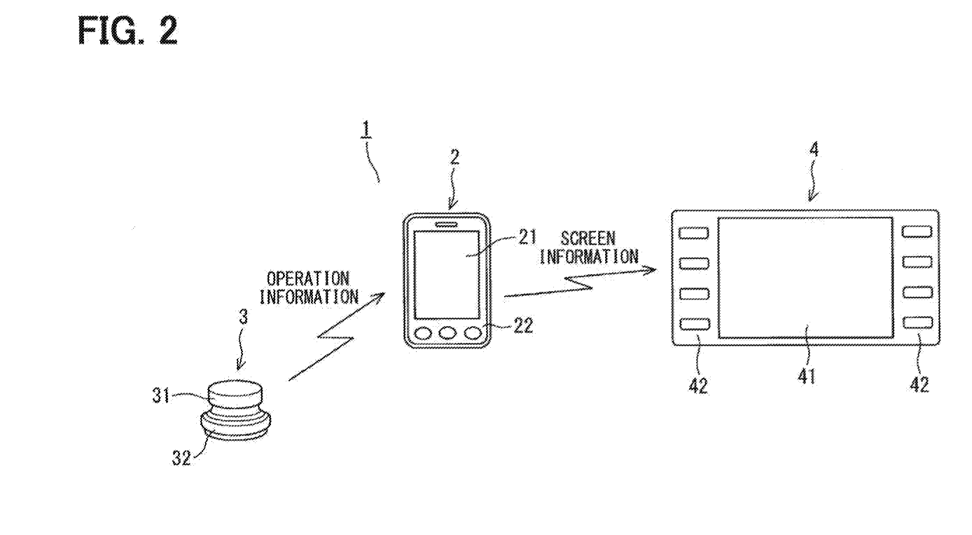

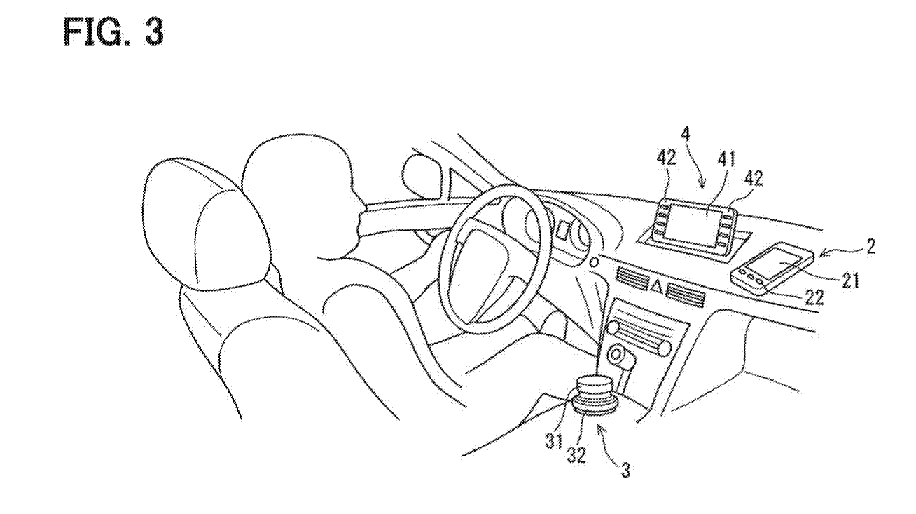

A portable terminal operation system 1 includes a portable terminal 2 which is carriable by a user (e.g., a driver of a vehicle), a controller 3 which is operable by the user, and a vehicle device 4 which is installed inside a vehicle cabin. As illustrated in FIG. 2, the portable terminal 2 is, for example, a multifunctional cellular phone called a smartphone. The portable terminal 2 includes a liquid crystal display unit 21 which displays various screens (e.g., a home screen) and receives a user operation through a touch panel and an operation unit 22 which includes various buttons (e.g., a home button). As illustrated in FIG. 3, the portable terminal 2 is mounted on, for example, a dashboard in the vehicle cabin. However, the portable terminal 2 may not be necessarily mounted on the dashboard, for example, may be put in a breast pocket of clothes of the user or in a bag because an operation to the portable terminal 2 is prohibited when the portable terminal 2 and the vehicle device 4 are communicably connected.

The controller 3 is a dedicated device for remotely operating the portable terminal 2. The controller 3 includes an operation knob 31 for being operated by a user and a base 32 for fixing the operation knob 31 inside the vehicle cabin. In the controller 3, the operation knob 31 is formed in a substantially cylindrical shape and has a size that enables a user to fit the operation knob 31 in the palm or hold the operation knob 31 with the fingers to operate the operation knob 31. The controller 3 is mounted at a position that enables a user to reduce sight line movement from the front side and easily operate the controller 3, for example, a center console located between a driver's seat and a passenger seat in the vehicle cabin. In this case, the controller 3 may be fixedly mounted or may be detachably mounted. As a method for mounting the controller 3 inside the vehicle cabin, for example, a magnetic force may be used or a dedicated holder may be provided.

The vehicle device 4 includes a liquid crystal display unit 41 which displays various screens (e.g., a menu screen, a destination setting screen, and a map screen) and receives a user operation through a touch panel and an operation unit 42 which includes various buttons (e.g., a menu button and a volume control button). The vehicle device 4 is mounted at a position that enables a user to reduce view line movement from the front side and visually recognize the screen, for example, the dashboard in the vehicle cabin.

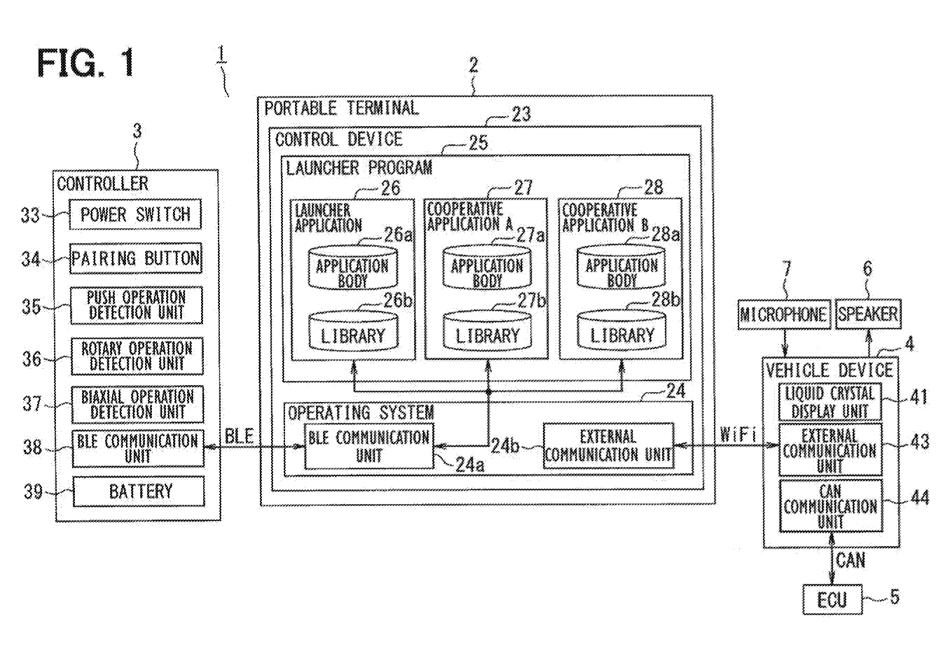

Next, a configuration including a principal part of the present disclosure of each of the potable terminal 2, the controller 3, and the vehicle device 4 will be described. As illustrated in FIG. 1, the portable terminal 2 has a control device 23 which includes a central processing unit (CPU). The control device 23 is capable of executing a launcher program 25 on an operating system 24. The operating system 24 includes a BLE communication unit 24a which controls Bluetooth (registered trademark) low energy (LE) (hereinbelow, referred to as BLE) communication with the controller 3 and an external communication unit 24b which controls wireless fidelity (WiFi, registered trademark) communication with the vehicle device 4, and controls each short-range wireless communication. In the configuration that uses BLE as a communication system between the portable terminal 2 and the controller 3 in this manner, the portable terminal 2 serves as a master device and the controller 3 serves as a slave device, so that the controller 3 transmits an advertising packet. In the present embodiment, WiFi is described as an example of a communication system between the portable terminal 2 and the vehicle device 4. Alternatively, a wireless communication system such as Bluetooth or a wired communication system such as a high definition multimedia interface (HDMI, registered trademark) or universal serial bus (USB) may be employed.

The launcher program 25 provides a user interface such as displaying a list of various cooperative applications (i.e., a cooperative application) such as destination retrieval and route guide in cooperation with the vehicle device 4. The control device 23 starts a launcher application 26 which is previously installed in the portable terminal 2 and cooperative applications 27, 28 which are downloaded from a server (not illustrated) by executing the launcher program 25. The launcher application 26 includes an application body 26a which is a program for achieving the function of the application and a library 26b which is a program for receiving an operation from the controller 3. The cooperative applications 27, 28 respectively include application bodies 27a, 28a which are programs for achieving the functions of the respective applications and libraries 27b, 28b (a disconnection request transmission device, a connection request transmission device) which are programs for receiving an operation from the controller 3.

The libraries 26b, 27b, 28b respectively function as conversion programs which convert operation information transmitted from the controller 3 into information receivable by the application bodies 26a, 27a, 28a. The libraries 26b, 27b, 28b are provided from a manufacturer of the controller 3. Thus, an implementor of the launcher application 26 and the cooperative applications 27, 28 can achieve the function of receiving the operation from the controller 3 by merely implementing the libraries 26b, 27b, 28b without taking into consideration short-range wireless communication with the controller 3 and the conversion of operation information. Note that two or more launcher applications may be provided, and three or more cooperative applications may be provided.

The controller 3 includes a power switch 33, a pairing button 34, a push operation detection unit 35, a rotary operation detection unit 36, a biaxial operation detection unit 37, a BLE communication unit 38, and a battery 39. That is, the controller 3 is battery-driven (i.e., battery-driven) and requires no power cable or the like for acquiring operating power when used.

The power switch 33 is operated by a user for switching the controller 3 between on and off (start and stop). The pairing button 34 is operated by a user for performing pairing with the portable terminal 2. Pairing information such as a password required to perform pairing is fixedly set in the controller 3. Accordingly, when the controller 3 is started near the portable terminal 2, pairing is automatically performed. The push operation detection unit 35 detects a push operation of pushing the operation knob 31 toward the base 32 by a user. The rotary operation detection unit 36 detects a rotary operation of relatively rotating the operation knob 31 with respect to the base 32 by a user. The biaxial operation detection unit 37 detects a biaxial operation of tilting the operation knob 31 to either of two axial directions which are perpendicular to each other at the center of the base 32 by a user. In this manner, the controller 3 is configured to receive an operation that is more simplified than an operation performed by a user with respect to a touch panel of the portable terminal 2. That is, in the portable terminal 2, a user performs operations in accordance with a physical law such as a touch operation, a flick operation, a swipe operation, and a drag operation to the touch panel. In these operations, it is necessary to fix the eyes on the screen or continuously keep a finger in contact with the touch panel. On the other hand, in the controller 3, it is not necessary for a user to perform a continuous operation such as moving a finger along the touch panel, and an intermittent operation such as an operation to a switch can be performed. Thus, the operability is remarkably simplified.

The BLE communication unit 38 controls BLE communication with the portable terminal 2. The BLE communication unit 38 transmits operation information that indicates operations performed by a user to the switch 33, the pairing button 34 and the operation knob 31 (the push operation, the rotary operation, and the biaxial operation) to the portable terminal 2.

The vehicle device 4 includes the liquid crystal display unit 41, an external communication unit 43, and a controller area network (CAN) communication unit 44. The external communication unit 43 controls WiFi communication with the portable terminal 2. The CAN communication unit 44 controls data communication conforming to the CAN communication standard with various electric control units (ECUs) 5 mounted on the vehicle. A speaker 6 which outputs a voice and a microphone 7 which inputs a voice are connected to the vehicle control device 4.

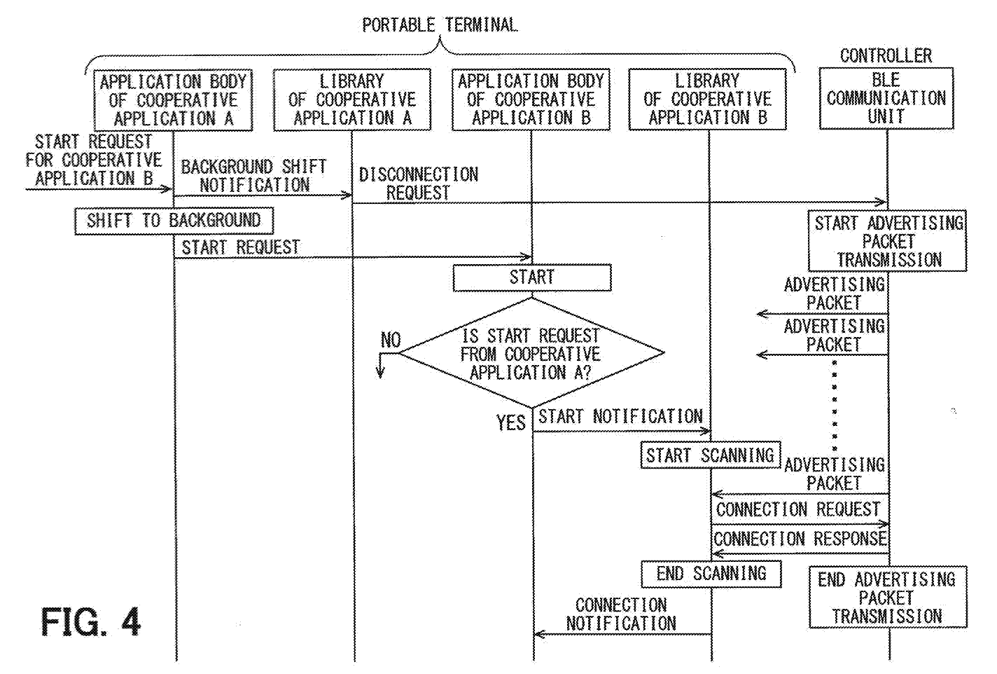

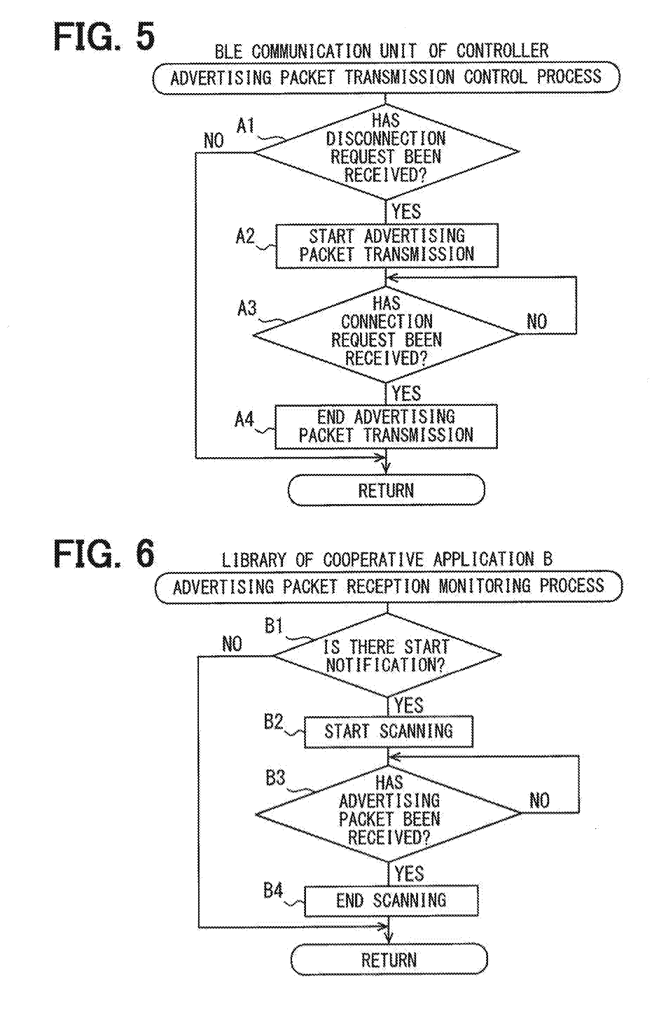

Next, the action of the above configuration will be described also with reference to FIGS. 4 to 9. In the portable terminal device 2, the control device 23 controls connection and disconnection of BLE communication with the controller 3 by executing a communication control program. FIG. 4 illustrates a case in which WiFi connection has already been established between the portable terminal 2 and the vehicle device 4, and a start request for a cooperative application B (the cooperative application 28 in FIG. 1, a second cooperative application) is generated while a cooperative application A (the cooperative application 27 in FIG. 1, a first cooperative application) is running in the portable terminal 2. The BLE communication unit 38 of the controller 3 executes an advertising packet transmission control process illustrated in FIG. 5. A library of the cooperative application B executes an advertising packet reception monitoring process illustrated in FIG. 6. While the cooperative application A is running in the portable terminal 2, screen information of the cooperative application A is transmitted from the portable terminal 2 to the vehicle device 4 and screen of the cooperative application A is displayed on the liquid crystal display unit 41 of the vehicle device 4.

In the portable terminal 2, for example, when an application body of the cooperative application A receives a start request for the cooperative application B produced by a start operation for the cooperative application B performed by a user, the application body of the cooperative application A notifies a library of the cooperative application A of a background shift notification, shifts to a background, and notifies an application body of the cooperative application B of the start request. When the library of the cooperative application A is notified of the background shift notification from the application body of the cooperative application A, the library of the cooperative application A transmits a disconnection request from the BLE communication unit 24a to the BLE communication unit 38 of the controller 3 (performs a disconnection request transmission process). The present disclosure is not limited to the background shift notification notified from the application body of the cooperative application A to the library of the cooperative application A. The background shift notification may be notified from the body of the portable terminal to the library of the cooperative application A. Further, the disconnection request transmission process may be a simple disconnection process.

When the BLE communication unit 38 of the controller 3 receives the disconnection request from the library of the cooperative application A (A1: YES in FIG. 5), the BLE communication unit 38 starts the transmission of an advertising packet (A2 in FIG. 5), and waits for the reception of a connection request from an external side (A3 in FIG. 5). The BLE communication unit 38 of the controller 3 transmits the advertising packet to retrieve another device that is present around the BLE communication unit 38 and is BLE-connectable with the BLE communication unit 38. Thereafter, the BLE communication unit 38 of the controller 3 continuously transmits the advertising packet until receiving the connection request from the external side.

On the other hand, when the application body of the cooperative application B is notified of the start request from the application body of the cooperative application A, the application body of the cooperative application B starts and determines whether the start request is from the cooperative application A. When the application body of the cooperative application B determines that the start request is from the cooperative application A, the application body of the cooperative application B notifies the library of the cooperative application B of a start notification. When the library of the cooperative application B is notified of the start notification from the application body of the cooperative application B (B1: YES in FIG. 6), the library of the cooperative application B starts scanning (B2 in FIG. 6) and monitors the reception of the advertising packet (B3 in FIG. 6). The present disclosure is not limited to the start notification notified from the application body of the cooperative application B to the library of the cooperative application B. The start notification may be notified from the body of the portable terminal to the library of the cooperative application B.

As described above, the BLE communication unit 38 of the controller 3 continuously transmits the advertising packet. Thus, the library of the cooperative application B promptly receives the advertising packet. When the library of the cooperative application B determines that the advertising packet has been received (B3: YES in FIG. 6), the library of the cooperative application B transmits a connection request from the BLE communication unit 24a to the BLE communication unit 38 of the controller 3 (performs a connection request transmission process). When the BLE communication unit 38 of the controller 3 receives the connection request from the library of the cooperative application B (A3: YES in FIG. 5), the BLE communication unit 38 transmits a connection response to the library of the cooperative application B and ends the transmission of the advertising packet (A4 in FIG. 5). When the library of the cooperative application B receives the connection response from the BLE communication unit 38 of the controller 3, the library of the cooperative application B ends the scanning (B4 in FIG. 6) and notifies the application body of the cooperative application B of a connection notification. That is, after the BLE communication unit 38 of the controller 3 starts the transmission of the advertising packet in response to the disconnection request received from the library of the cooperative application A, the BLE communication unit 38 ends the transmission of the advertising packet in response to the connection request received from the library of the cooperative application B. This prevents the BLE communication unit 38 of the controller 3 from continuously transmitting the advertising packet, which reduces power consumption required for the transmission of the advertising packet.

When the controller 3 succeeds in the retrieval of the portable terminal 2, pairing between the controller 3 and the portable terminal 2 is started.

When the pairing has been completed, the transmission of operation information from the controller 3 to the portable terminal 2 is enabled, and the operation of the controller 3 to the portable terminal 2 is enabled. That is, when a user operates the controller 3, the controller 3 transmits operation information to the portable terminal 2. For example, when a user performs a push operation, the controller 3 transmits operation information indicating that the push operation has been performed to the portable terminal 2. The library of the cooperative application B converts the operation performed to the controller 3 by the user into running information for running the application body of the cooperative application B and notifies the application body of the cooperative application B of the running information. Then, the application body of the cooperative application B runs according to the operation performed to the controller 3 by the user in response to the running information notified from the library of the cooperative application B. When the application body of the cooperative application B runs in this manner, the transmission of screen information from the portable terminal 2 to the vehicle device 4 is enabled, and a screen corresponding to the screen information is displayed on the liquid crystal display unit 41. This enables the user to operate the portable terminal 2 by the operation to the controller 3 which is easier than the operation to the touch panel of the portable terminal 2, without fixing the eyes on the screen of the portable terminal 2.

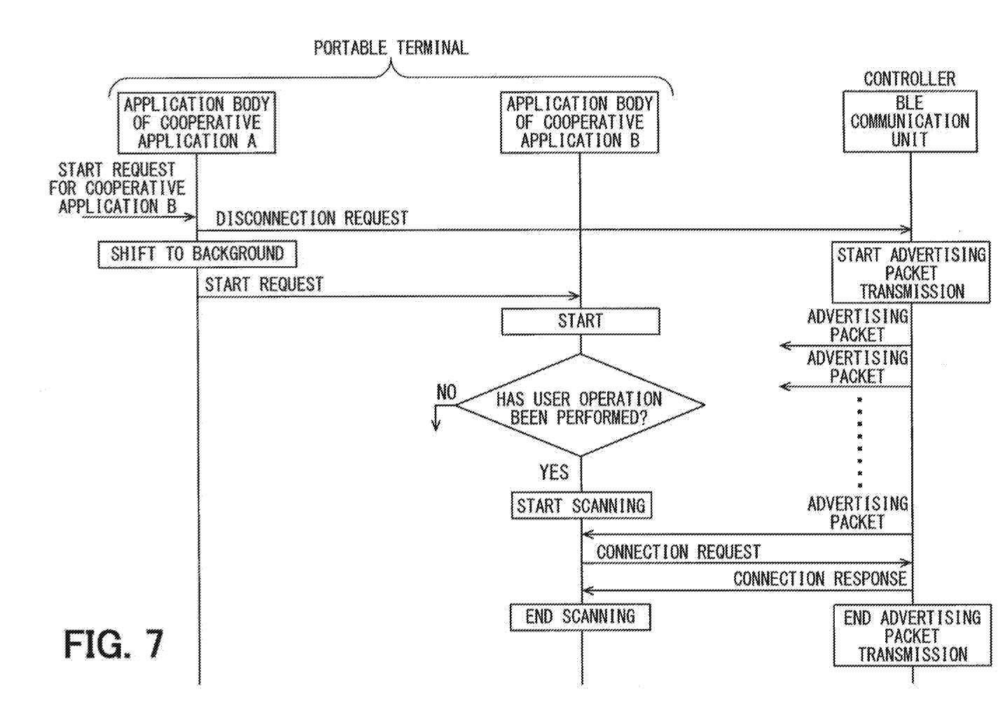

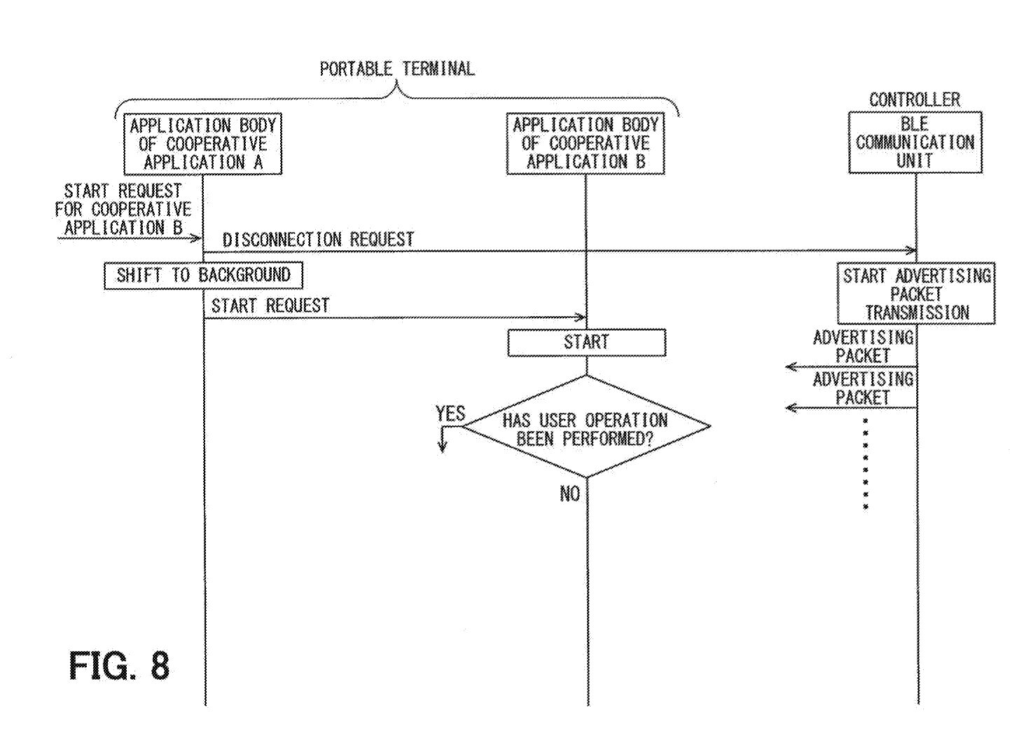

For comparison with the present disclosure, a case in which a library for controlling the connection and disconnection of BLE communication in this manner is not incorporated in a cooperative application will be described with reference to FIGS. 7 and 8. In this case, when the application body of the cooperative application A receives a start request for the cooperative application B, the application body of the cooperative application A transmits a disconnection request from the BLE communication unit 24a to the BLE communication unit 38 of the controller 3, shifts to the background, and notifies the application body of the cooperative application B of the start request. When the application body of the cooperative application B is notified of the start request from the application body of the cooperative application A, the application body of the cooperative application B starts and does not start scanning. In this case, the application body of the cooperative application B determines whether a user operation for a connection request from the portable terminal 2 to the controller 3 (e.g., depression of a “controller connection start” button) has been performed. When the application body of the cooperative application B determines that the user operation has been performed, the application body of the cooperative application B transmits a connection request from the BLE communication unit 24a to the BLE communication unit 38 of the controller 3. On the other hand, when the application body of the cooperative application B determines that the user operation has not been performed, a connection request is not transmitted. That is, the BLE communication unit 38 of the controller 3 does not receive a connection request from the application body of the cooperative application B unless the user operation is performed. Thus, the BLE communication unit 38 of the controller 3 continuously transmits the advertising packet until the user operation is performed.

On the other hand, in the present finding, the library for monitoring the reception of the advertising packet is incorporated in the cooperative application. Thus, when a start request is notified from the cooperative application A, a connection request is transmitted upon receiving the advertising packet. As a result, the transmission of the advertising packet from the controller 3 thereafter can be ended. Thus, it is possible to avoid unnecessary transmission of the adverting packet to thereby reduce power consumption in the BLE communication unit 38 of the controller 3.

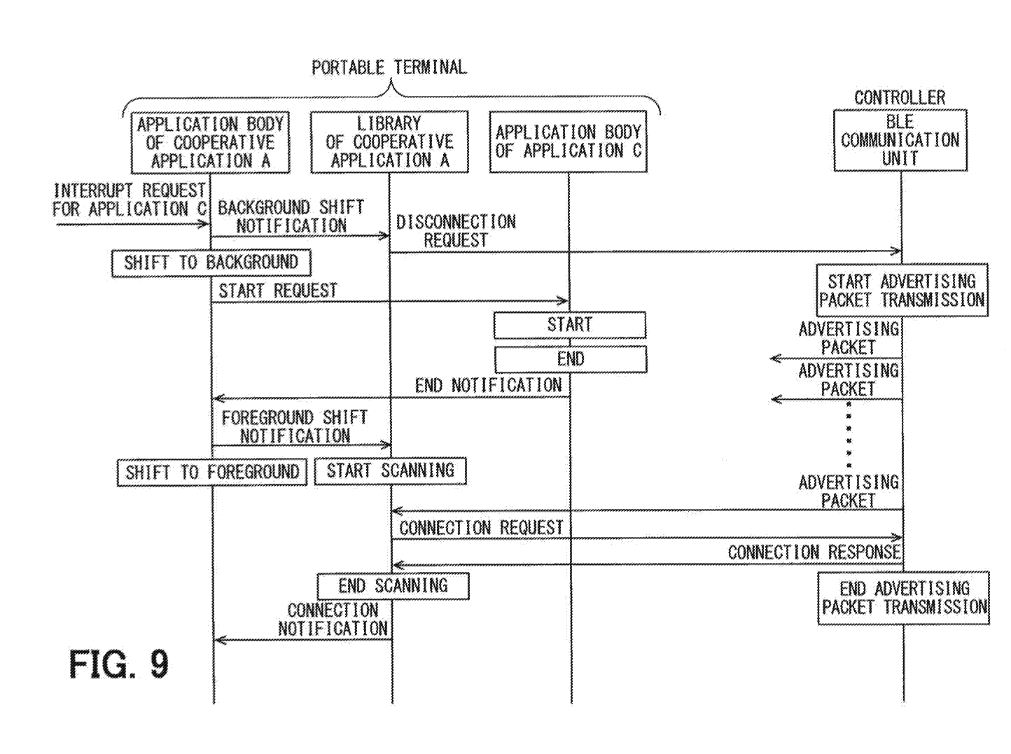

FIG. 9 illustrates a case in which WiFi connection has already been established between the portable terminal 2 and the vehicle device 4 and an interrupt request for a different application C is generated while the cooperative application A is running in the portable terminal 2. In the portable terminal 2, when the application body of the cooperative application A receives an interrupt request for the different application C, for example, when a user temporarily operates the portable terminal 2 to perform an interrupt operation for the different application C by a screen operation other than a launcher application, the application body of the cooperative application A notifies the library of the cooperative application A of a background shift notification, shifts to the background, and notifies an application body of the different application C of a start request.

When the library of the cooperative application A is notified of the background shift notification from the application body of the cooperative application A, the library of the cooperative application A transmits a disconnection request from the BLE communication unit 24a to the BLE communication unit 38 of the controller 3 (performs a disconnection request transmission process). The present disclosure is not limited to the background shift notification notified from the application body of the cooperative application A to the library of the cooperative application A. The background shift notification may be notified from the body of the portable terminal to the library of the cooperative application A. Further, the disconnection request transmission process may be a simple disconnection process. When the BLE communication unit 38 of the controller 3 receives the disconnection request from the library of the cooperative application A, the BLE communication unit 38 starts the transmission of an advertising packet and waits for the reception of a connection request from an external side. Also in this case, the BLE communication unit 38 of the controller 3 continuously transmits the advertising packet thereafter until receiving the connection request from the external side.

On the other hand, when the application body of the different application C is notified of the start request from the application body of the cooperative application A, the application body of the different application C starts. Thereafter, the application body of the different application C notifies the application body of the cooperative application A of an end notification when ended. When the application body of the cooperative application A is notified of the end notification from the application body of the different application C, the application body of the cooperative application A notifies the library of the cooperative application A of a foreground shift notification and shifts to a foreground. When the library of the cooperative application A is notified of the foreground shift notification from the application body of the cooperative application A, the library of the cooperative application A starts scanning and monitors the reception of the advertising packet. The present disclosure is not limited to the foreground shift notification notified from the application body of the cooperative application A to the library of the cooperative application A. The foreground shift notification may be notified from the body of the portable terminal to the library of the cooperative application A.

As described above, the BLE communication unit 38 of the controller 3 continuously transmits the advertising packet. Thus, the library of the cooperative application A receives the advertising packet. When the library of the cooperative application A determines that the advertising packet has been received, the library of the cooperative application A transmits a connection request from the BLE communication unit 24a to the BLE communication unit 38 of the controller 3 (performs a connection request transmission process). When the BLE communication unit 38 of the controller 3 receives the connection request from the library of the cooperative application A, the BLE communication unit 38 transmits a connection response to the library of the cooperative application A and ends the transmission of the advertising packet. When the library of the cooperative application A receives the connection response from the BLE communication unit 38 of the controller 3, the library of the cooperative application A ends the scanning and notifies the application body of the cooperative application A of a connection notification. That is, after the BLE communication unit 38 of the controller 3 starts the transmission of the advertising packet in response to the disconnection request received from the library of the cooperative application A, the BLE communication unit 38 of the controller 3 ends the transmission of the advertising packet in response to the disconnection request received from the library of the cooperative application A. This prevents the BLE communication unit 38 of the controller 3 from continuously transmitting the advertising packet, which reduces power consumption required for the transmission of the advertising packet also in this case.

As described above, the embodiment can obtain the following effects.

In the portable terminal 2, the library for controlling the connection and disconnection of BLE communication is incorporated in the cooperative application. Accordingly, when a start request for the cooperative application B is generated while the cooperative application A is running, the library of the cooperative application B starts scanning and monitors the reception of the advertising packet when notified of a start notification from the application body of the cooperative application B. When the library of the cooperative application B receives the advertising packet, the library of the cooperative application B transmits a connection request to the BLE communication unit 38 of the controller 3. The BLE communication unit 38 of the controller 3 ends the transmission of the advertising packet in response to the connection request received from the library of the cooperative application B. As a result, it is possible to prevent the BLE communication unit 38 of the controller 3 from continuously transmitting the advertising packet to thereby reduce power consumption required for the transmission of the advertising packet.

When an interrupt request for the different application C is generated while the cooperative application A is running, the library of the cooperative application A starts scanning and monitors the reception of the advertising packet when notified of a foreground shift notification from the application body of the cooperative application A. When the library of the cooperative application A receives the advertising packet, the library of the cooperative application A transmits a connection request to the BLE communication unit 38 of the controller 3. The BLE communication unit 38 of the controller 3 ends the transmission of the advertising packet in response to the connection request received from the library of the cooperative application A. As a result, also in this case, it is possible to prevent the BLE communication unit 38 of the controller 3 from continuously transmitting the advertising packet to thereby reduce power consumption required for the transmission of the advertising packet.

The present disclosure is not limited to the examples in the above embodiment, and modifications or extensions may be made in any manner without departing from the scope thereof.

In the present embodiment, the case in which a start request for the cooperative application B is generated while the cooperative application A is running has been described as an example. However, the same applies to a case in which a start request for the cooperative application A is generated while the corporative application B is running. Further, in the present embodiment, the case in which an interrupt request for the different application C is generated while the cooperative application A is running has been described as an example. However, the same applies to a case in which an interrupt request for the different application C is generated while the cooperative application B is running.

In the present embodiment, the configuration in which the library of the cooperative application monitors the reception of the advertising packet in the portable terminal 2 by BLE communication performed between the portable terminal 2 and the controller 3 has been described as an example. However, the library of the cooperative application may monitor the reception of a packet (connection standby packet) having an equivalent property as the advertising packet using another short-range wireless communication system.

In the drawings, the portable terminal operation system is denoted by 1, the portable terminal is denoted by 2, the controller is denoted by 3, the control device is denoted by 23, and the libraries of the cooperative applications (the disconnection request transmission device, the connection request transmission device) are denoted by 27b, 28b.

It is noted that a flowchart or the processing of the flowchart in the present application includes sections (also referred to as steps), each of which is represented, for instance, as A1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A portable terminal for providing a portable terminal operation system together with a controller that starts transmission of a connection standby packet when receiving a disconnection request from an external device and ends the transmission of the connection standby packet when receiving a connection request from the external device, the portable terminal comprising:
a disconnection request transmission device that transmits the disconnection request to the controller when notified that an application body of a first cooperative application shifts to a background in a case where a start request for a second cooperative application is generated while the first cooperative application is running; and
a connection request transmission device that starts monitoring reception of the connection standby packet from the controller when notified that the second cooperative application has been started in a case where the start request is notified from the application body of the first cooperative application to an application body of the second cooperative application, and transmits the connection request to the controller when receiving the connection standby packet from the controller.

2. The portable terminal according to claim 1, wherein:
the disconnection request transmission device is provided by a first library incorporated in the first cooperative application; and
the connection request transmission device is provided by a second library incorporated in the second cooperative application.

3. A portable terminal for providing a portable terminal operation system together with a controller that starts transmission of a connection standby packet when receiving a disconnection request from an external device and ends the transmission of the connection standby packet when receiving a connection request from the external device, the portable terminal comprising:
a disconnection request transmission device that transmits the disconnection request to the controller when notified that an application body of a cooperative application shifts to a background in a case where an interrupt request from a different application or a body of the portable terminal generated while the cooperative application is running; and
a connection request transmission device that starts monitoring of reception of the connection standby packet from the controller when notified that the application body of the cooperative application shifts to a foreground, and transmits the connection request to the controller when receiving the connection standby packet from the controller.

4. The portable terminal according to claim 3, wherein:
the disconnection request transmission device and the connection request transmission device are provided by a library incorporated in the cooperative application.

5. The portable terminal according to claim 1, wherein:
the connection request transmission device monitors reception of an advertising packet defined by a Bluetooth LE communication standard as the monitoring of the reception of the connection standby packet.

6. A portable terminal operation system comprising:
the portable terminal according to claim 1; and
a controller that starts the transmission of the connection standby packet when receiving the disconnection request from the external device and ends the transmission of the connection standby packet when receiving the connection request from the external device.

7. (canceled)

8. (canceled)

9. A communication control method for a portable terminal providing a portable terminal operation system together with a controller that starts transmission of a connection standby packet when receiving a disconnection request from an external device and ends the transmission of the connection standby packet when receiving a connection request from the external device, the communication control method comprising:
transmitting the disconnection request to the controller when notified that an application body of a first cooperative application shifts to a background in a case where a start request for a second cooperative application is generated while the first cooperative application is running; and
starting monitoring of reception of the connection standby packet from the controller when notified that the second cooperative application has been started in a case where the start request is notified from the application body of the first cooperative application to an application body of the second cooperative application, and transmitting the connection request to the controller when receiving the connection standby packet from the controller.

10. A communication control method for a portable terminal providing a portable terminal operation system together with a controller that starts transmission of a connection standby packet when receiving a disconnection request from an external device and ends the transmission of the connection standby packet when receiving a connection request from the external device, the communication control method comprising:
transmitting the disconnection request to the controller when notified that an application body of a cooperative application shifts to a background in a case where an interrupt request from a different application or a body of the portable terminal is generated when the cooperative application is running; and
starting monitoring of reception of the connection standby packet from the controller when notified that the application body of the cooperative application shifts to a foreground, and transmitting the connection request to the controller when receiving the connection standby packet from the controller.
